(19) United States
(12) Patent Application Publication
(10) Pub. No.: US 2010/0303540 A1
(43) Pub. Date: Dec. 2, 2010

(54) APPARATUS FOR CONNECTING BARS

(76) Inventors: Seo Ji Kim, Incheon (KR); Yu Sie Kim, Incheon (KR); Young Sook Choi, Incheon (KR)

Correspondence Address: Hyun Jong Park;Park & Associates Intellectual Property Law LLC, Suite 106, 265 Bic Drive, Milford, CT, 06461, US

(21) Appl. No.: 12/756,349

(22) Filed: Apr. 8, 2010

(30) Foreign Application Priority Data
May 30, 2009 (KR) 10-2009-0047868
Feb. 9, 2010 (KR) PCT/KR2010/000773

(51) Int. Cl. F16B 7/00

(52) U.S. Cl. 403/305

(57) ABSTRACT

The apparatus 100 for connecting bars according to the present invention comprises a pair of bodies 100 for receiving the bars 1, the pair of bodies having cylindrical shape which faces from each other; a plurality of stoppers 120 for firmly holding the bars 1, the plurality of stoppers 120 provided in the pair of bodies in two steps or several steps; a spring 130 for elastically longitudinally supporting the pair of bodies 110, the spring 130 provided in the bottom surface of the plurality of stoppers 120; and an elastic ring 140 for elastically supporting the plurality of stoppers 120 in the radial direction of the pair of bodies, the elastic ring 140 provided on the inner peripheral surface of the plurality of stoppers 120.

### REFERENCE TO RELATED APPLICATIONS

This application is a continuation of PCT international application Ser. No. PCT/KR2010/000773 filed on Feb. 9, 2010, which designates the United States and claims priority of KR Application Serial No. 10-2009-0047868, filed May 30, 2009, the entire contents of which are incorporated herein by reference.

### FIELD OF THE INVENTION

The present invention relates to an apparatus for connecting bars, and more particularly, to an apparatus for connecting bars enabling to easily and firmly connect two or more reinforcing rods or pipes.

### BACKGROUND OF THE INVENTION

As one of apparatus for connecting bars such as reinforcing rods or pipes, there is “Joint for Pipes” of Korean Registered Utility Model No. 20-0347218.

As shown in FIG. 6, the conventional joint for pipes has a couple of bodies 20.

The couple of bodies 20 are arranged such that pipes 10 are respectively inserted into both entrances 26 thereof, and the entrances 26 are installed with a cork 28 for preventing dust or wastewater being penetrated therethrough.

The bodies 20 are formed with a taper portion 23 on the inner wall thereof such that the inner diameter thereof is gradually greater inwardly, and a recess portion 22 is formed under the taper portion 23. A jaw 21 is formed in the portion which connects the taper portion 23 and the recess portion 22.

The recess portion 22 is installed with a packing 27 for sealing the joint 10 therein, and the jaw 21 is installed with a snap ring 29. The stopper 25 for firmly holding the pipes 10 is installed in the bodies 20 to be moved according to the taper portion 23, and a spring 24 is installed between the snap ring 29 and the stopper 25 to longitudinally give elastic force to the stopper 25. And, the last portion 24a of the spring 24 is inserted in the recess formed on the stopper 25.

In the conventional joint for pipes with the above described structure, the whole joint including the stopper 25 should be greater to increase the contacting area between the stopper 25 and the pipe 10 and the contacting area between the stopper 25 and the body 20 which require to sustain sufficient force to connect the pipes 10 since the stopper 25 is one step. Therefore, the joint is limited to be further smaller, which increases its manufacturing cost and impedes the work efficiency.

In specific, it is important that a coupler for connecting reinforcing rods or a connector for wire ropes should embody to keep the nature tensile and yield strength of the connected objects and also to sustain safe connecting force even its smaller size.

### SUMMARY OF THE INVENTION

The present invention is created to solve a problem of the above-mentioned prior art, and accordingly the object of the present invention provides an apparatus for connecting bars enabling to keep the nature tensile and yield strength thereof even its smaller size, to decrease its manufacturing cost and to impede the work efficiency by making the stopper in two steps and by increasing the contacting area between a stopper and the bars and the contacting area between the stopper and its body in the limited space.

In order to achieve the above-described object, the present invention provides an apparatus for connecting bars comprising a pair of bodies for receiving the bars, the pair of bodies having cylindrical shape which faces from each other; a plurality of stoppers for firmly holding the bars, the plurality of stoppers provided in the pair of bodies in two steps or several steps; a spring for elastically longitudinally supporting the pair of bodies, the spring provided in the bottom surface of the plurality of stoppers; and an elastic ring for elastically supporting the plurality of stoppers in the radial direction of the pair of bodies, the elastic ring provided on the inner peripheral surface of the plurality of stoppers.

In the apparatus for connecting bars, the ratio of the outer diameter (D) of the pair of bodies and the outer diameter (d) of the bars is 9:5.

In the apparatus for connecting bars, the minimum thickness of the pair of bodies is greater 40% of the difference between the pair of bodies' radius and the bars' radius.

In the apparatus for connecting bars, the total length (L) of the pair of bodies is 1.8˜2.0 times of its outer diameter (D) when the plurality of stoppers are mounted in two steps.

In the apparatus for connecting bars, the total length (L) of the pair of bodies is 2.4˜2.6 times of its outer diameter (D) when the plurality of stoppers are mounted in three steps.

In the apparatus for connecting bars, the pair of bodies has a slanted surface in two or several steps in longitudinal direction thereof to receive the plurality of stoppers, wherein the slanted surface has a slanted angle of 10°˜20° or the slanted surface has a slanted angle of 12°˜15°.

In the apparatus for connecting bars, the plurality of stoppers have a conical shape having cut end thereof, and they are divided in three to six in their peripheral direction, wherein the plurality of stoppers are formed with a plurality of serrated protrusions having a right-angled triangle on the inner surface thereof.

In the apparatus for connecting bars, the plurality of stoppers are formed with a ring inserting recess for receiving the elastic ring on the inner surface thereof, wherein the elastic ring is “C” type.

In the apparatus for connecting bars, the spring is a coil spring or a wave spring.

According to the apparatus for connecting bars of the present invention, the tensile and yield strength thereof is increased even its smaller size since the stopper is designed in two steps and the contacting area between a stopper and the bars and the contacting area between the stopper and its body are increased in the limited space.

The apparatus may be designed to connect any reinforced rods or wire ropes and to embody the lower manufacturing cost and higher work efficiency since the contacting area between a stopper and the bars and the contacting area between the stopper and its body are increased even its smaller size.

### BRIEF DESCRIPTION OF THE DRAWINGS

The above and other objects and advantages of the present invention will become readily apparent by reference to the following detailed description when considered in conjunction with the accompanying drawing wherein:

FIG. 1 is a broken perspective view schematically illustrating the apparatus for connecting bars according to a preferred embodiment of the present invention;

FIG. 2 is a cross-sectional view schematically illustrating the apparatus for connecting bars in which the stoppers are mounted in two steps;

FIG. 3 is a cross-sectional view schematically illustrating the apparatus for connecting bars in which the stoppers are mounted in three steps;

FIG. 4 is a cross-sectional view schematically illustrating a bar is begun to be inserted into the apparatus in FIG. 2;

FIG. 5 is a cross-sectional view schematically illustrating a bar is fully inserted into the apparatus in FIG. 2; and

FIG. 6 is a cross-sectional view schematically illustrating the conventional joint for pipes.

### DETAILED DESCRIPTION OF THE INVENTION

Hereinafter, the apparatus for connecting bars according to preferred embodiment of the present invention will be described in detail with reference to the accompanying drawings.

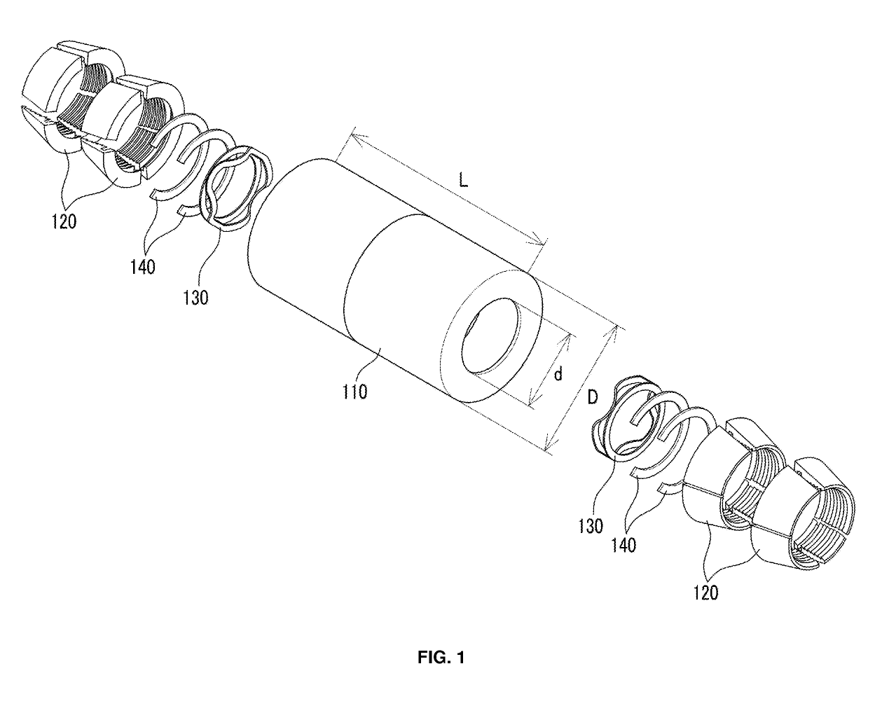

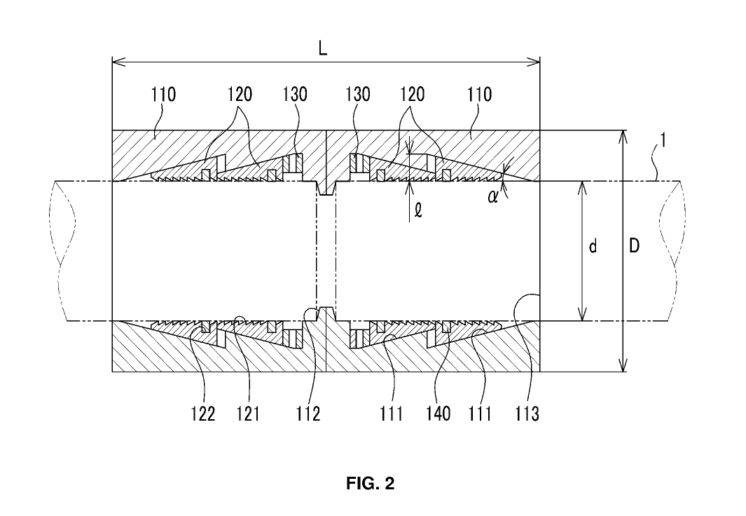

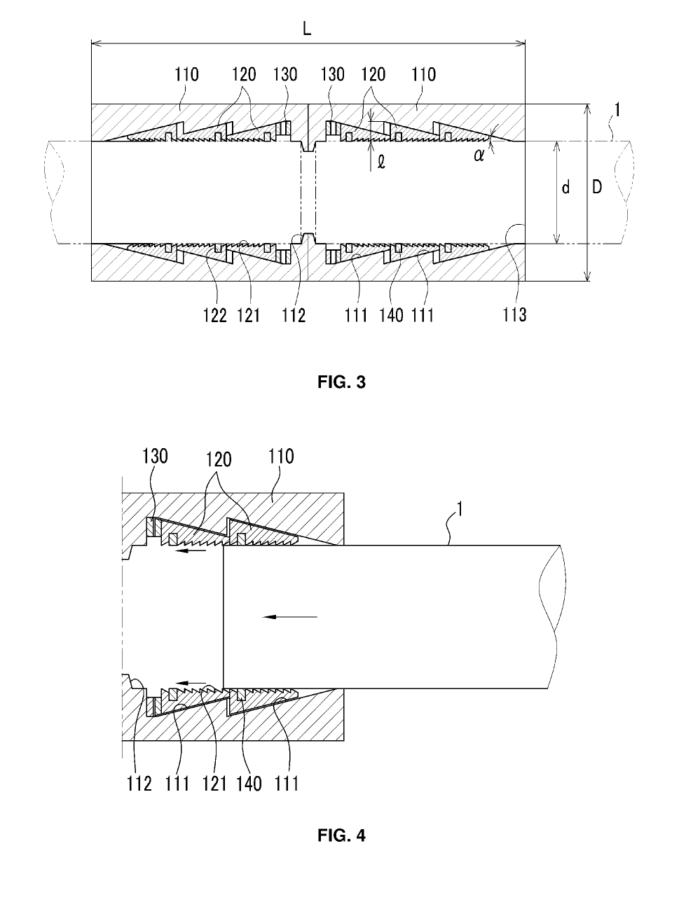

The apparatus for connecting bars according to a preferred embodiment of the present invention is described with reference to FIGS. 1, 2 and 3. FIG. 1 is a broken perspective view schematically illustrating the apparatus for connecting bars according to a preferred embodiment of the present invention, FIG. 2 is a cross-sectional view schematically illustrating the apparatus for connecting bars in which the stoppers are mounted in two steps, and FIG. 3 is a cross-sectional view schematically illustrating the apparatus for connecting bars in which the stoppers are mounted in three steps.

As shown in FIGS. 1, 2 and 3, the apparatus 100 for connecting bars according to this embodiment comprises a pair of bodies 110, a plurality of stoppers 120, a spring 130 and an elastic ring 140.

The pair of bodies 110 are for receiving objects such as bars 1, and it has cylindrical shape which faces from each other. The body 110 is longitudinally formed with a slanted surface 111 in two steps according to the inner peripheral surface thereof, and a jaw 112 where the bar 1 will be held is formed on the middle of the slanted surface 111. The pair of bodies 110 are integrally manufactured, or they may be separately manufactured and then integrally connected by welding or by any disassemble mean such as bolt and nut.

The biting integrity of the wedge for the bars is improved according to the steps of the mounted stopper 120. And, the body may be designed to have minimum outer diameter because the stopper 120 may disperse the force given to the body 110 without the change of the slanted angle (α) of the stopper 120. For example, the stopper in one step should have the greater length (I) of the bottom side of the slanted surface to have same effect with several steps of stopper with the same slanted angle, which causes the thickness of the body 110 to be greater than the stoppers in several steps. In a case that the length (I) of the bottom side of the slanted surface is same but the slanted angle (α) is different, the stopper in one step should have greater thickness of the body 110 than the stoppers in several steps to correspond the force to be given to the body 110 by the stopper 120 according to the decreased amount of the slanted angle (α) in the inclined plane principle. Therefore, the minimum size of apparatus for safely connect bars from each other may be designed when the stopper is mounted in several steps.

To design the apparatus of the present invention to have the tensile and yield strength corresponding to that of the connected objects and to consider the size of the stopper 120, it is preferable that the ratio of the outer diameter (D) of the body 110 and the outer diameter (d) of the bar 1 should be 9:5.

When the minimum thickness of the body 110 is over 40% of the difference between the body's radius and the bar's radius {(D−d)/2}, the body 110 may be designed to have the minimum outer diameter such that the minimum sectional area of the body 110 is over that of the bar 1. This results the expression of 0.4 {(D−d)/2}×(D−0.8)>(d/2)².

The total length (L) of the pair of bodies 110 is preferable to be about 1.8˜2.0 times of its outer diameter (D) when the stoppers are mounted in two steps, and it is preferable to be about 2.4˜2.6 times of its outer diameter (D) when the stoppers are mounted in three steps.

The slanted angle (α) of the slanted surface 111 is preferable to be about 10°˜20°, further preferable to be 12°˜15°.

The plurality of stoppers 120 are for firmly holding the bar, and they have a conical shape having cut end thereof to correspond the slanted surface 111. The stoppers 120 are formed to be divided in three to six in its peripheral direction to surround the bar so as to increase the convenience in assembly. The stopper 120 has an outer surface which is flat and an inner surface which is longitudinally formed with a plurality of serrated protrusions 121 with a constant space. The serrated protrusions 121 have roughly a right angled triangle, and the stopper 120 is provided in the body 110 such that the oblique side of the stopper 120 faces to the opening 113 of the body 110. And, the stopper 120 is formed with a ring inserting recess 122 on the inner surface thereof to be located between the serrated protrusions 121.

The spring 130 is for elastically longitudinally supporting the plurality of stoppers 120, and it is provided near the jaw 112 formed in middle of the body 110 to support the bottom surface of the stopper 120. As the spring, a coil spring or a wave spring may be applied, and some wave spring was applied in this embodiment. If the wave spring is applied, the space defined between the bottom surface and the bottom side of the slanted surface of the body 110 is decreased, which causes the total length of the body 110 to be shorter. This makes more economical and efficient design to be possible.

The plurality of stoppers 120 are pushed toward the opening 113 of the body 110 by the elastic force of the spring 130, and then the oblique side of the stopper 120 is strongly contacted to the slanted surface 111 of the body 110.

The elastic ring 140 is for elastically radially supporting the plurality of stoppers 120, and it is inserted in the ring inserting recess 122 formed on the stopper 120. As the elastic ring 140, an annular ring or a C-type ring may be applied.

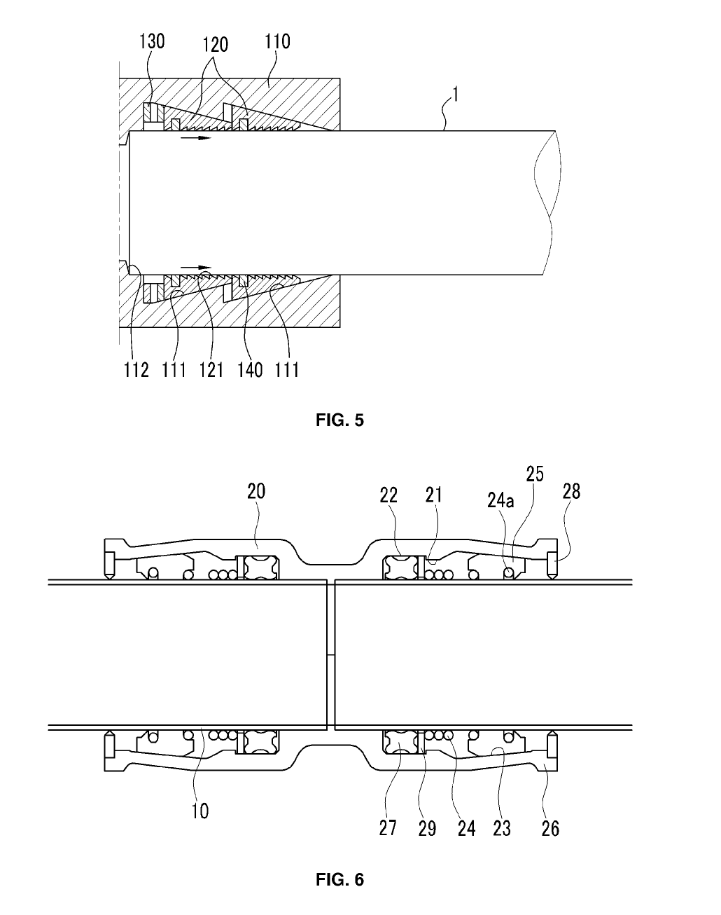

The process to connect the bars to the apparatus of the present invention having the above-described structure is illustrated in FIGS. 4 and 5.

As shown in FIG. 4, when the bar 1 is begun to be inserted into the body 110 through the opening 113, the stopper 120 is pushed in the body 110 following to the inserting direction of the bar 1 since the friction force between the serrated protrusions 121 of the stopper 120 and the bar 1 is greater than the elastic force of the spring 130. At this time, the friction force becomes to be gradually weak when a gap between the serrated protrusions 121 and the bar 1 is begun appeared since the stopper 120 is moved following to the slanted surface 111 in outer radial direction of the body 110.

Meanwhile, as shown in FIG. 5, when the bar 1 is fully inserted in the body to be held by the jaw 112, the stopper 120 is pushed in its original position since the elastic force of the spring 130 is greater than the friction fore between the serrated protrusions 121 of the stopper 120 and the bar 1. At this time, the serrated protrusions 121 of the stopper 120 are strongly contacted to the outer peripheral surface of the bar 1, and then the bar 1 is further firmly held by the apparatus 100 since the slanted direction of the protrusions 121 is opposite to the separating direction of the bar 1.

In this embodiment, as an example of the bar, a pipe is applied, but any various objects having stick shape such as a pipe, a reinforced rod, a wire rope made by twisted wires may be connected by the apparatus of the present invention. Also, in this embodiment, two bars are connected in series, but alternatively several bars may be variously connected in T-type or L-type by the apparatus of the present invention according to working condition.

Although the preferred embodiment of the present invention has been described, it is understood that the present invention should not be limited to this preferred embodiment but various changes and modifications can be made by one skilled in the art within the sprit and scope of the present invention aimed.

What is claimed is:

1. An apparatus for connecting bars comprising:
a pair of bodies for receiving the bars, the pair of bodies having cylindrical shape which faces from each other;
a plurality of stoppers for firmly holding the bars, the plurality of stoppers provided in the pair of bodies in two steps or several steps;
a spring for elastically longitudinally supporting the pair of bodies, the spring provided in the bottom surface of the plurality of stoppers; and
an elastic ring for elastically supporting the plurality of stoppers in the radial direction of the pair of bodies, the elastic ring provided on the inner peripheral surface of the plurality of stoppers.

2. The apparatus according to claim 1, wherein the ratio of the outer diameter (D) of the pair of bodies and the outer diameter (d) of the bars is about 9:5.

3. The apparatus according to claim 1, wherein the minimum thickness of the pair of bodies is greater than 40% of the difference between the pair of bodies' radius and the bars' radius.

4. The apparatus according to claim 1, wherein the total length (L) of the pair of bodies is about 1.8 to 2.0 times of its outer diameter (D) when the plurality of stoppers are mounted in two steps

5. The apparatus according to claim 1, wherein the total length (L) of the pair of bodies is about 2.4 to 2.6 times of its outer diameter (D) when the plurality of stoppers are mounted in three steps.

6. The apparatus according to claim 1, wherein the pair of bodies has a slanted surface in two or several steps in longitudinal direction thereof to receive the plurality of stoppers.

7. The apparatus according to claim 6, wherein the slanted surface has a slanted angle of about 10° to 20°.

8. The apparatus according to claim 7, wherein the slanted surface has a slanted angle of about 12° to 15°.

9. The apparatus according to claim 1, wherein the plurality of stoppers have a conical shape having cut end thereof, and they are divided in three to six in their peripheral direction.

10. The apparatus according to claim 9, wherein the plurality of stoppers are formed with a plurality of serrated protrusions having a right-angled triangle on the inner surface thereof.

11. The apparatus according to claim 1, wherein the plurality of stoppers are formed with a ring inserting recess for receiving the elastic ring on the inner surface thereof.

12. The apparatus according to claim 11, wherein the elastic ring is “C” type.

13. The apparatus according to claim 1, wherein the spring is a coil spring or a wave spring.
